(19) United States
(12) Patent Application Publication
(10) Pub. No.: US 2008/0282871 A1
(43) Pub. Date: Nov. 20, 2008

(54) Portable karaoke device

(76) Inventor: Kuo Hsiung Chen, Kowloon (CN)

Correspondence Address: ALIX YALE & RISTAS LLP, 750 MAIN STREET, SUITE 1400, HARTFORD, CT, 06103, US

(21) Appl. No.: 12/082,306

(22) Filed: Apr. 10, 2008

(30) Foreign Application Priority Data
Apr. 11, 2007 (CN) 200720146513.9

(51) Int. Cl. G10H 1/36

(52) U.S. Cl. 84/610; 434/307 A

(57) ABSTRACT

A type of portable karaoke device includes a microphone, a twist knob control, several control buttons and a composite A/V output. There is an audio processor and a MPEG decoder inside the microphone. That audio processor is used to receive audio signals from the microphone and voice signals created by the MPEG decoder, and then conduct audio processing for these signals. On the other hand, that MPEG decoder is used to receive karaoke signals and control signals, and then conduct decoding and audio and video processing for these signals. The twist knob control is on the surface of the microphone, and can be used to adjust the volume or move the cursor by turning left or right. Several control buttons are on the surface of the microphone. Control signals can be generated by pressing. Audio and video output ports are set outside the microphone, it can transmit the video and audio signals from the karaoke device to another visual display device (e.g. TV).

### TECHNICAL FIELDS

The utility model relates to a karaoke device, particularly a portable karaoke device.

### BACKGROUND TECHNOLOGIES

Bustles about in the life in nowadays, lots of people sing heartily during free time as a leisure activity. When we do not have an accompanist, and do not wish to perform sonorous singing, the karaoke device become convenient and important. Along with the technical progress, many karaoke devices are easily seen in daily life. It is very common for groups of good friends to go to KTV and sing joyfully and heartily using the karaoke devices.

To some people who need to stay at home and it is not convenient for them to go to KTV, they have to use home karaoke equipment when they wish to sing joyfully a tune. However, the size of the said karaoke equipment is like a box. It is not easy to carry and is required to be used with an external microphone for enjoyment. Moreover, the video and song data for playing on the karaoke system are saved in compact discs or read-only memories for which it is not easy to update the video and song data. However, for those young people who like pop music, their favourable songs are changing all the time. Such karaoke device are no longer be able to meet the needs of the young people.

As such, many electronic products entrepreneur take this advantage of opportunity by offering karaoke equipment with microphone in one set to facilitate users to carry this conveniently. When users want to sing joyfully, they are only required to connect the portable karaoke devices with display units (e.g., televisions) and can then sing freely and joyfully.

FIG. 1 is a kind of traditional portable karaoke device. Such traditional portable karaoke device devices include a microphone 10, a set of control buttons 11, a power on/off slide button 12 and an indicator light 13. Among them, the bottom part of the microphone 100 has a memory card slot (CARD_IN) and a composite A/V output (TV_OUT). The set of control buttons 11 is on the surface of the microphone 10, including the first control button 110, the second control button 111 and the third control buttons 112. The power on/off slide button 12 is on the surface of the microphone 10, while the indicator light 13 is also set outside the microphone 10. Inside the microphone 10, there is an audio processor 101 and a MPEG decoder 102. Those control buttons 110, 111, 112 are used to generate control signals (C_IN) in order to control the karaoke device, e.g., controlling the volume, adjusting echo sound effect, changing the voice and pitch as well as editing the playlist. The power on/off slide button 12 can be connected to one power source for turning the karaoke device on or off. The indicator light 13 is used to indicate the current status of the device, such as stand-by mode, power on or low power voltage. The memory card slot (CARD_IN) allows the slot-in of an external memory card for receiving karaoke song signals (D_IN) from the memory card, and then transmit these signals to the MPEG decoder 102. The MPEG decoder 102 receives control signals (C_IN) from the control buttons 110, 112 and karaoke song signals (D_IN) from the memory card. After the MPEG decoder 102 has conducted decoding and audio and video processing to signals C_IN and D_IN, a video signal (V_OUT) will be transmitted to composite A/V output (TV_OUT), and a voice signal (A_IN) will be transmitted to the audio processor 101. The audio processor 101 receives audio signal (S_IN) from the microphone (10) 10 and the processed voice signal (A_IN) from MPEG decoder, and conduct appropriate audio processing to signals A_IN and S_IN, then releases the left channel signal (A_L_OUT) and right channel signal (A_R_OUT) to the composite A/V output (TV_OUT). The composite A/V output (TV_OUT) release signals A_L_OUT, A_R_OUT, V_OUT received through the transmission line to TV.

However, volume adjustment of traditional portable karaoke device is usually made via the control of buttons or the connected display device. Therefore, you may be required to use both hands if you need to pause for control of the portable karaoke device. This is definitely very inconvenient and ruins the enjoyable ambience. Since traditional portable karaoke device are inconvenient for control, it may create an uncomfortable feeling to the users.

Hence, to save the above troubles, a special design of a twist knob control is employed for the portable karaoke device.

### SUMMARY

A new type of portable karaoke device employs a twist knob control. That twist knob control can be used to move a cursor (on a display device) or adjust volume. This enables users to control the device easily with a single hand while singing karaoke, further enhancing the convenience in operation.

This utility model offers a type of portable karaoke device which includes a microphone, a twist knob control, several control buttons and a composite A/V output. There is an audio processor and a MPEG decoder inside the microphone. That audio processor is used to receive audio signal from the microphone and voice signal created by the MPEG decoder, and then conduct audio processing for these signals. On the other hand, that MPEG decoder is used to receive karaoke signals and control signals, and then conduct decoding and audio-video processing for these signals. The twist knob control is on the surface of the microphone, which can be used to adjust the volume or move the cursor by turning the twist knob control left or right. Several control buttons are on the surface of the microphone, and the control signals can be generated by pressing the control buttons. Audio and video ports are set outside the microphone for transmitting the video and audio signals from the karaoke device to other visual display device (e.g. TV).

The portable karaoke device includes a memory card slot that is set outside the microphone. That memory card slot can be connected with an external memory card recorded with the desired karaoke data for providing karaoke signals to the portable karaoke device.

The portable karaoke device includes a built-in memory storage device and a USB port. That memory storage device is built inside the microphone, while the USB port is set outside the microphone. That memory storage device can record the desired karaoke data and provides karaoke signals to the portable karaoke device. The USB port is for connection with a computer which makes information uploading and downloading between the computer and the memory storage device possible.

A long or short press on those control buttons can create different control signals. By using long and short press on control buttons as well as rotating the twist knob control, an a user can access the user interface provided by this portable karaoke device, and thus control the volume of the left and right channels, echo sound effect, auto song playlist setting, stereo/left-right mono channel interchange and cursor movement.

As for the implementation of this portable karaoke device, if the portable karaoke device has stopped or paused for a period of time and the control buttons have not been pressed or the twist knob control have not been rotated, the portable karaoke device will enter the stand-by mode. To restart the device, simply press any control button or rotate the twist knob control. If the portable karaoke device is in stand-by mode for more than 1 hour, the portable karaoke device will turn off automatically.

This portable karaoke device is more user-friendly with the adoption of the above features. Now, users can use the twist knob control to adjust the volume and move the cursor (on a display device). In addition, the automatic stand-by and turn off function of this portable karaoke device can save unnecessary waste of electricity.

The aforementioned are only the overview of the portable karaoke device. In order to allow for a better understanding of this device, it will be exemplified and illustrated in more detail below.

### BRIEF DESCRIPTION OF THE DRAWINGS

FIG. 1 is an embodiment of a traditional portable karaoke device;

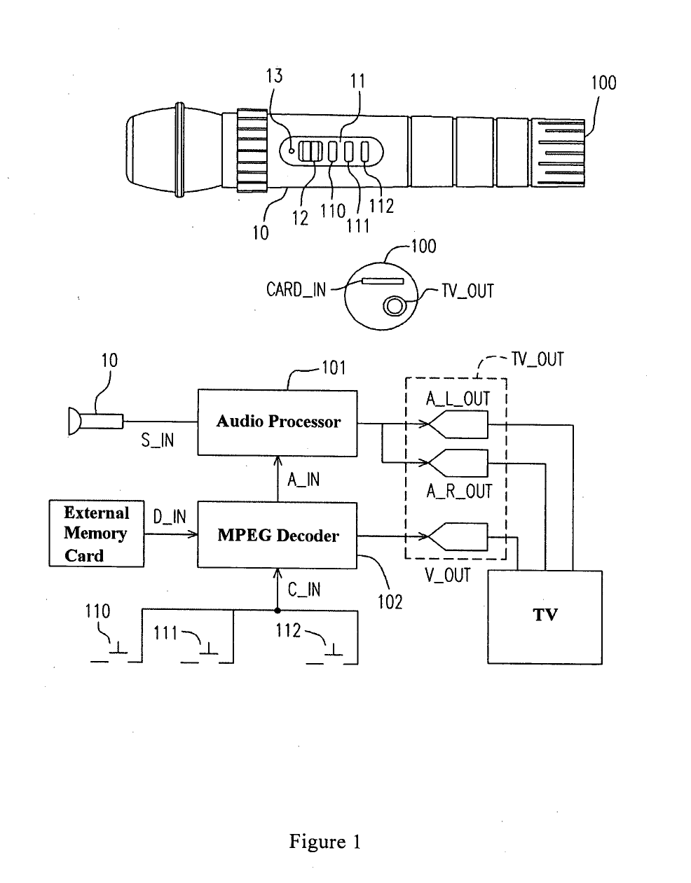

FIG. 2 is a first embodiment of a portable karaoke device; and

FIG. 3 is a second embodiment of a portable karaoke device.

### DETAILED DESCRIPTION

The features and functionalities of this portable karaoke device are set out as below:

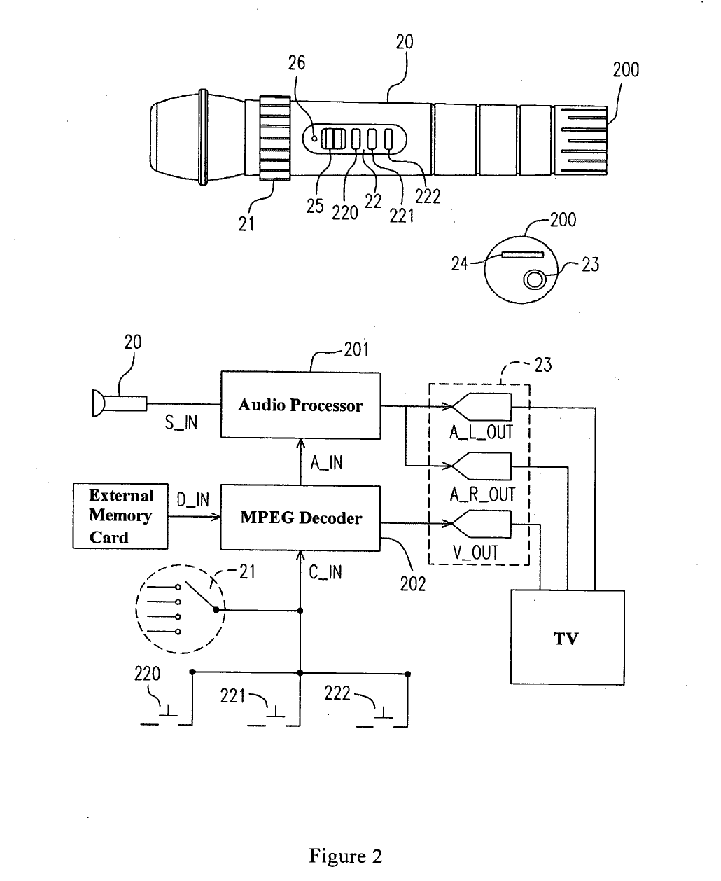

With reference to the embodiment of FIG. 2, a portable karaoke includes a microphone 20, a twist knob control 21, a set of control buttons 22, a composite A/V output 23, an external memory card slot 24, a mechanical power on/off slide button 25 and a blue/red indicator light 26. The twist knob control 21 is located on the surface of the microphone 20. The set of control buttons 22 are also on the surface of the microphone 20. The composite A/V output 23 is set at the bottom part of the microphone 200, while the memory card slot 24 is also set at the bottom of the microphone 200. The mechanical power on/off slide button 25 is set on the surface of the microphone 20. The blue/red indicator light 26 is also on the surface of the microphone 20. Inside the microphone 20 there is an audio processor 201 and a MPEG decoder 202. The set of control buttons 22 includes the first control button 220, the second control button 221 and the third control button 222.

When the user utters a voice, microphone 20 will transmit the received audio signal (S_IN) to its built-in audio processor 201. The audio processor 201 will also receive audio signal (A_IN) from the MPEG decoder 202, the audio processor 201 will then conduct audio processing to signal A_IN and S_IN and then release audio signal A_L_OUT and audio signal A_R_OUT to the left channel and right channel respectively. MPEG decoder 202 receive control signals (C_IN) generated from control buttons 220, 222 and twist knob control 21 as well as karaoke data (D_IN) from the external memory card. After MPEG decoder 202 conduct decoding and A/V processing to signal A_IN, C_IN and D_IN, a video signal (V_OUT) is released to the composite A/V output (TV_OUT) and a voice signal (A_IN) to the audio processor (201). The twist knob control 21 can be rotated from left or right direction for adjusting volume or moving the cursor. Each single button 220, 222 from the set of control buttons 22 can be pressed to control the control signals (C_IN). The composite A/V output 23 is set outside the microphone, which is used to receive audio signal A_L_OUT and A_R_OUT from the left channel and right channel after processed by the audio processor respectively. It also receives video signal (V_OUT) decoded and processed by the MPEG decoder. The composite A/V output 23 can transmit the above signals to a visual display device through the cable. The memory card slot 24 connects with the external memory card, whereas the external memory card can record desired karaoke data and provides karaoke signals (D_IN) to the portable karaoke device. The mechanical power on/off slide button 25 connects the power source (for example 3 AA battery cells) and is used for turning the portable karaoke device on and off. A blue/red indicator light 26 is used to indicate the status of the portable karaoke device, e.g. when the blue light 26 is on, the power is on; when the red light 26 is on, it indicates a low power voltage; when the red light 26 flashes, the device is on stand-by mode.

The above portable karaoke device further provides a user interface which can be displayed on visual device (e.g. TV) for easy operation by users. That user interface supports English, Japanese, and Korean. Users can set the default language interface that is suitable for them.

Moreover, a long or short press on those control buttons 220, 222 of the button set 22 can create different control signals. By using user interface, control buttons 22 and twist knob control 21, users can control volume of stereo channels, echo sound effect and auto song playlist setting, stereo/left-right mono channel interchange and the cursor movement.

Besides, if the portable karaoke device has stopped or paused for a period of time and if the control buttons 22 are not pressed or twist knob control 21 are not being rotated, the portable karaoke device will enter the stand-by mode. To restart the portable karaoke device, simply press any control button 220, 222 or rotate the twist knob control 21. If the portable karaoke device is in stand-by mode for more than 1 hour, then the portable karaoke device will turn off automatically.

The aforementioned composite A/V output 23 can be in Audio Video Interleave (AVI), MPEG2 and MPEG4 or other video format. Henceforth, users can play files of different quality and configuration in different formats.

Based on the above information, we will use a practical example to better illustrate the function of the device and thus allow technicians to have a better understanding on this device. After the user connects the composite A/V output 23 through the transmitting cable, he/she can simply turn on the machine by sliding the on/off button up 25. Then, MPEG decoder 202 will automatically read the memory card. MPEG decoder 202 will transmit all the stored song playlists to TV through the composite A/V output 23 and the playlist will be displayed on TV. The user can then rotate the twist knob control 21 (the user can move the cursor downward or rightward by rotating the twist knob control to the right direction, moving upward or leftward by rotating it to the left direction), while the first control button 220 is for editing the playlist. After finishing choosing the songs from the playlist, simply press the second control button 221 and the user can finish the editing and start playing the list. While the playlist is on, the user can rotate the twist knob control 21 to adjust volume (reducing volume by turning it to the left; increasing volume by turning it to the right). Also, while the song list is playing, the user can indicate a pause by making a short press on control button 220; to keep repeating the current song by making a long press on control button 220 for 1.5 seconds; to cancel the repetition by making another long press on the first control button 220 for 1.5 seconds. If the user makes a short press on the second control button 221, the control unit 201 of user interface can be seen on the TV screen. If a long press is made on the second control button 221 for 1.5 seconds, the machine will skip to the next song (If a long press is made once before to the control buttons 220 for 1.5 seconds, then a long press on the second control button 221 for 1.5 seconds will make the machine replay the previous karaoke song). If the user makes a short press on the third control button 222, then an interchange between left/right channel will be made. If a long press is made on the third control button 222 for 1.5 seconds, it will change to stereo channels.

When the user enters into the user interface, he/she can use the twist knob control 21 for any cursor movement (the user can move the cursor downward or rightward by rotating the twist knob control to the right direction, moving upward or leftward by rotating it to the left direction) or volume and effect adjustments (turning to the left for reduction; turning to the right for increment). By then, if a short press is made on the first control button 220, the user can then enter into the menu bar; if a short press is made on the second control button 221, the user can then leave the user interface. In the user interface, the user can edit the playlist, set the song priority, set the volume of the microphone 20 and the extra second microphone, echo control, pitch adjustment, equalizer effect, language and TV configuration.

If that portable karaoke device is turned on but no song is being played, and given that no control button 220, 222 or twist knob control 21 is pressed or rotated within 8 minutes, the portable karaoke device will turn into stand-by mode, and the red indicator light 27 will flash. If that happens, simply press any control button 220, 222 or rotate the twist knob control 21, the portable karaoke device will be turned on again. If those control buttons 220, 222 and twist knob control 21 is not touched for 4 minutes, then the portable karaoke device will turn off automatically. At that time, the user must move the slide button 25 from “off” to “on” position in order to restart the device.

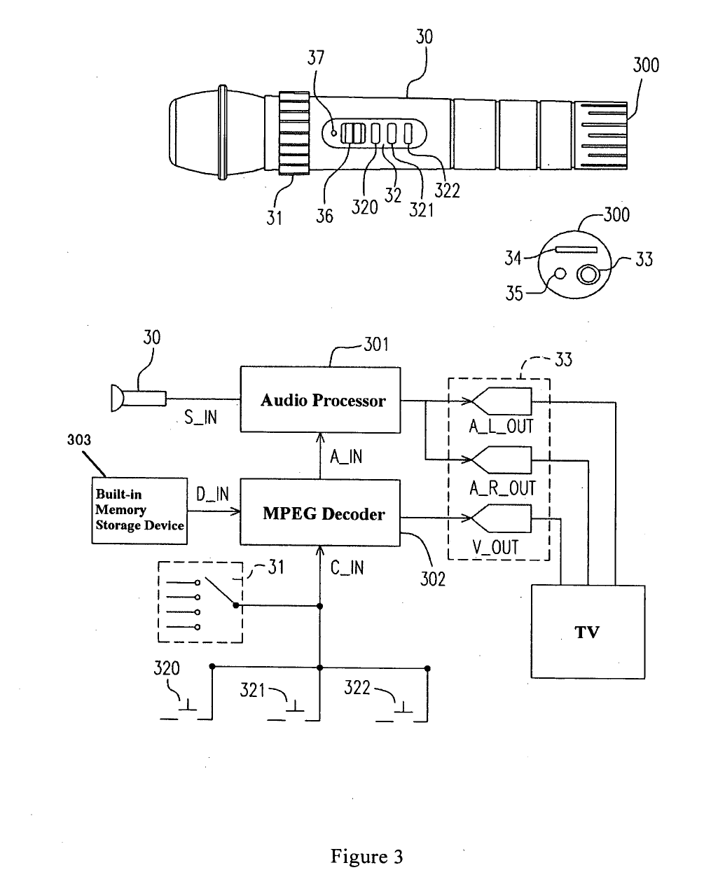

With reference to FIG. 3, which is a second embodiment, that portable karaoke device includes a microphone 30, a twist knob control 31, a set of control buttons 32, a composite A/V output 33, a USB port 34, the second microphone port 35, a mechanical power on/off slide button and a blue/red indicator light 37. Among them, the twist knob control is located on the surface of the microphone 30. The set of control buttons 32 is on the surface of the microphone. The composite A/V output 33 is at the bottom of the microphone 300, while the USB port 34 and the second microphone port 35 are also located on the same part of the microphone 300. The mechanical power on/off slide button 36 and the blue/red indicator light are on the surface of the microphone 30. 30 Inside the microphone 30, there is an audio processor 301, a MPEG decoder 302 and a built-in memory storage device 303. The audio processor 301 is connected with the MPEG decoder while the memory storage device 303 is connected with the MPEG decoder 302. The set of control buttons 32 includes the first control buttons 320, the second control button 321 and the third control button 322.

The only difference between the first embodiment and second embodiment is how the built-in memory 303 replaces the function of the external memory card, as well as an extra second microphone can be connected through the second microphone port 35. The USB port 34 can connect to a computer, making transmission of karaoke data (USB_Data) between computer and the built-in memory 303 possible. The second scheme and the first scheme show almost the same function, but for the second one, the built-in memory storage device 303 can be a flash memory storage device. The second microphone port 35 is used to connect the second microphone, and this second microphone only has the power on/off button (without the twist knob control and other buttons).

To conclude from the implementation example of this utility model, the portable karaoke device offered by this utility model uses the twist knob control to make volume adjustment and cursor movement much easier than traditional portable karaoke device. In addition, the automatic stand-by and turn-off function of this portable karaoke device can avoid unnecessary power consumption.

Above is a good example of an implementation of this invention, but this invention is not limited to the above implementation example. Other modifications, decorations, substitutions, combinations, and simplifications not against the essential nature and principle of this invention are all equivalent replacement modes within the protection range for this invention.

1. A portable karaoke device comprising:
a). a microphone with a built-in audio processor and a MPEG decoder said audio processor being used to receive the audio signals and voice signals generated through the said microphone and MPEG decoder respectively, and perform audio processing for these signals, said MPEG decoder being used to receive karaoke signals and control signals, and perform decoding and audio-video processing for these signals;
b). a twist knob control set on the surface of the microphone and being rotated for volume adjustment and cursor movement on a display device;
c). control buttons on the surface of the microphone for creating control signals to control the device; and
d). a composite A/V output that is set on the surface of the microphone for transmitting A/V signals from the karaoke device to a visual display device.

2. The portable karaoke device as mentioned in claim 1 in that the portable karaoke device includes a memory card slot, the said memory card slot being set on the surface of the microphone, which allows one to slot in an external memory card, wherein the external memory card can record those karaoke audio data one desires to play, and provide these karaoke signals to the portable karaoke device.

3. The portable karaoke device as mentioned in claim 1 in that the portable karaoke device also includes one blue/red indicator light shown on the surface of the microphone to indicate the status of the portable karaoke device, wherein when the blue light is on, the power is on and when the red light is on, it indicates a low power voltage and when the red light flashes, the device is on stand-by mode.

4. The portable karaoke device as mentioned in claim 1 in that the portable karaoke device also includes one mechanical power on/off slide button on the surface of the microphone, said button can being used to connect to the power source for controlling the on/off status of the portable karaoke device.

5. The portable karaoke device as mentioned in claim 1 in that the composite A/V output format can be in Audio Video Interleave (AVI), MPEG2 and MPEG4 format.

6. The other feature of the portable karaoke device as mentioned in claim 1 in that the portable karaoke device also includes a second microphone port, said port is set on the surface of the first microphone for connecting the second microphone, said second microphone having a power on/off slide button only.

7. The portable karaoke device as mentioned in claim 1 in that a longer press or a shorter press on the control buttons creates different control signals and in cooperation with the twist knob control and the user interface of the portable karaoke device allows the user to adjust the volume of stereo channels, echo sound effect and set auto song playlist, exchange the left and right channels of a stereo sound and move a cursor.

8. The portable karaoke device as mentioned in claim 1 and further comprising:
a). a memory storage device that is built inside the microphone, said memory device, which can record the desired karaoke information, and provide karaoke input signals for the portable karaoke device; and
b). a USB slot that is set on the surface of the microphone for connection to a computer, so as to make uploading and downloading information between computer and the said memory storage device possible.

9. The portable karaoke device as mentioned in claim 7 in that the user interface of the portable karaoke device supports English, Japanese, Korean and Chinese, and users can select the default language interface that is suitable for them.

10. The portable karaoke device as mentioned in claim 1 in that if the portable karaoke device is in the stop or pause mode for a period of time, and the control buttons have not been pressed or the twist knob control has not been rotated, the portable karaoke device will enter the stand-by mode, and then by simply pressing any control button or rotating the twist knob control, the portable karaoke device will restart again, and if the portable karaoke device is in stand-by mode for more than 1 hour, the portable karaoke device will turn off automatically.
